(19) United States
(12) Patent Application Publication
(10) Pub. No.: US 2005/0185410 A1
(43) Pub. Date: Aug. 25, 2005

(54) Floor lamp with retractable shade

(76) Inventors: Sheng-Huei Liao, Taichung City (TW); Huang-Chen Liao, Taichung City (TW)

Correspondence Address: LEONG C LEI, PMB # 1008, 1867 YGNACIO VALLEY ROAD, WALNUT CREEK, CA, 94598, US

(21) Appl. No.: 10/781,733

(22) Filed: Feb. 20, 2004

(51) Int. Cl. F21V 1/06

(52) U.S. Cl. 362/352

(57) ABSTRACT

A floor lamp with retractable shade to reduce storage or shipping space, the shade including multiple rings adhered with paper; a loop being provided at the center of the top support, a threaded rod being inserted through the loop and locked with a nut; a lower lever on the base of the lamp being curved with an arc at its center to bypass the post and stretch up the shade by means of a press disk and a compression coil; the press disk being pulled up to be freed from the lower lever; the top nub being released to remove the shade; and all rings being folded in for reducing packaging space.

### BACKGROUND OF THE INVENTION

(a) Technical Field of the Invention

The present invention is related to a floor lamp with a retractable shade; and more particularly, to one that allows reduction of storage or shipping space for the lamp.

(b) Description of the Prior Art

Whereas a lighting fixture also has the function of spatial decoration while lighting up the space, a lighting fixture of the prior art as illustrated in FIG. 6 of the accompanying drawings, is essentially comprised of a base (20) erected at its center a post (21), a bulb (22) and a shade frame (23) are respectively disposed at and fixed to the top of the post (21), and a shade (24) covers up the shade frame to either change the light emission orientation of the color of the light. However, the shade of the prior art is usually made of glass or plastic hard material; and to prevent parts from falling off, most shades are formed integrated in one piece. Therefore, when the lighting fixture is packaged for storage or shipping, the center of the shade indicates a hollow status to prevent from being folded in, thus to consume too much space otherwise should be saved. Furthermore, a shade made of glass is fragile and vulnerable to be broken into pieces while in transition. To improve this, the shade has been made into multiple pieces for combination. Still, such improvement fails to eliminate the flaws of being easily damaged, consuming too much packaging space and missing parts.

### SUMMARY OF THE INVENTION

The primary purpose of the present invention is to provide a floor lamp with a retractable shade allowing the shade to be removed for storage and shipping purpose. To achieve the purpose, the shade of the present invention is made of multiple rings into a tube with its exterior adhered with non-extendable paper. A loop is provided at the center of the upper lever to be inserted with a threaded rod and locked with a nut. A lower lever having at its center curved with an arc to bypass the post to hold the shade when stretched up by a press disk and a compression coil disposed on the base. When the floor lamp is in use, the shade is stretched up in a hollow tube; and when the floor lamp is packaged for storage or shipping, the press disk is pulled up to disengage from the lower lever on the base and the shade is removed by releasing the nut to fold in those multiple rings for saving packaging space and transportation cost.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of a preferred embodiment of the present invention.

FIG. 2 is a sectional view of the preferred embodiment of the present invention.

FIGS. 3, 3A-3B are a magnified view of local parts taken from FIG. 2.

FIG. 4 is a schematic view showing that the shade is collapsed.

FIG. 5 is an exploded view of another preferred embodiment of the present invention.

FIG. 6 is an exploded view of the prior art.

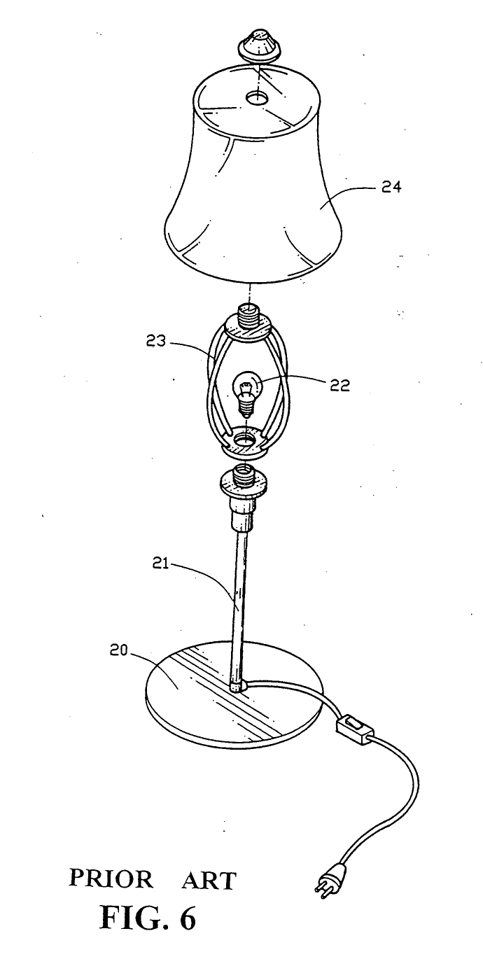

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

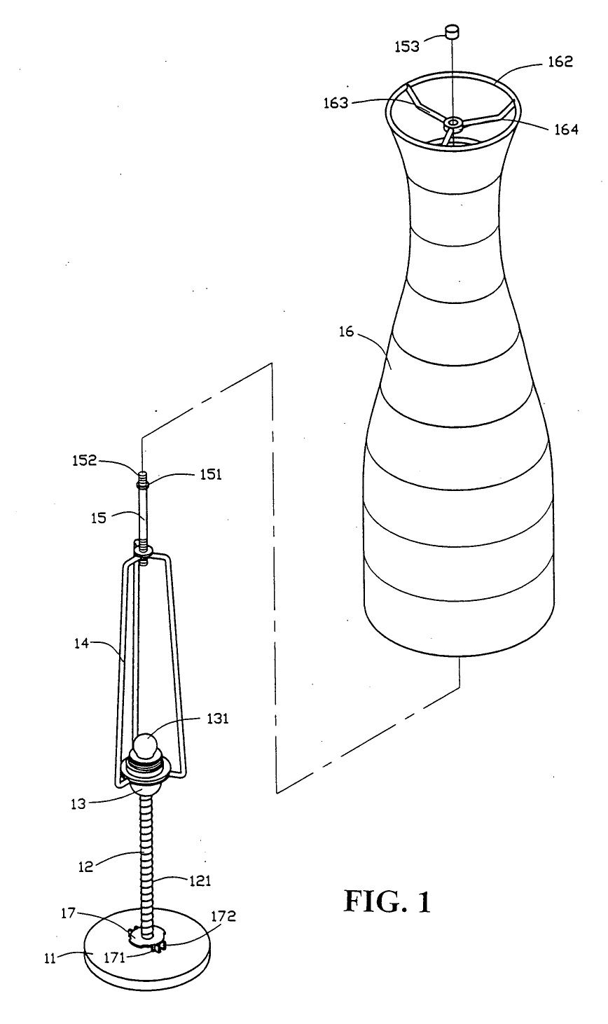

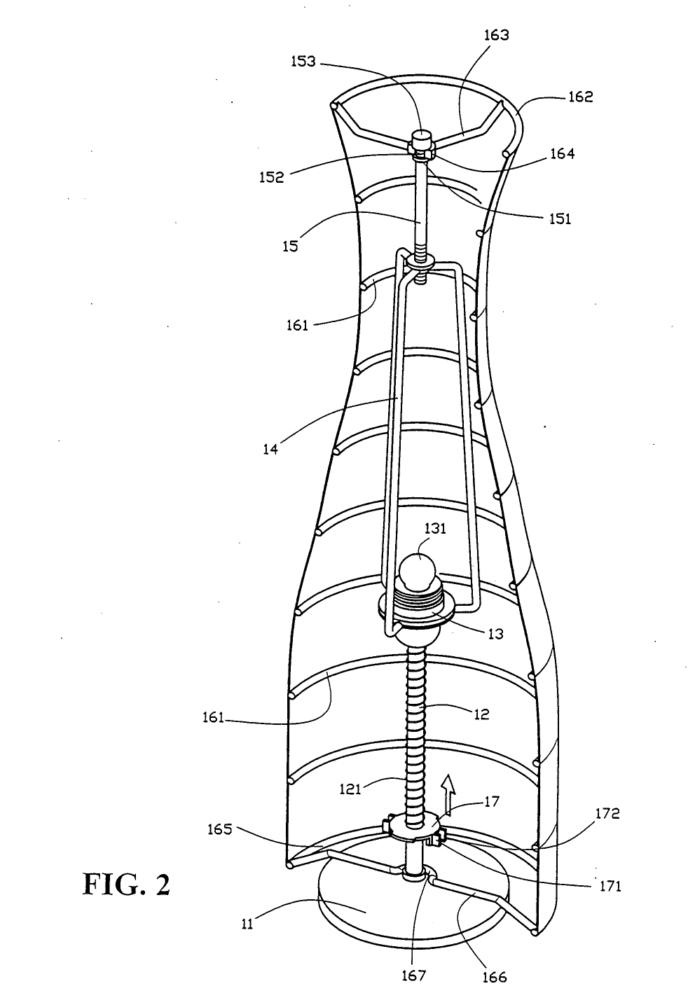

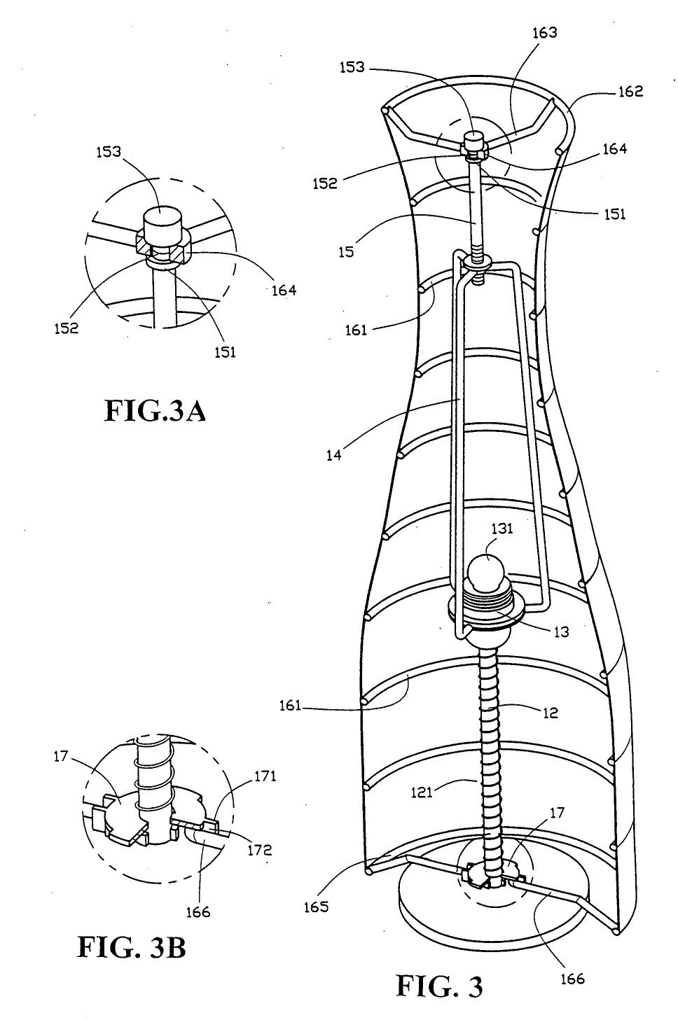

Referring to FIGS. 1, 2, 3, 3A and 3B for a preferred embodiment of the present invention, a post (12), a holder (13) adapted with a bulb (131), a support (14) and an adjusting threaded rod (15) are screwed in sequence upward from the center of a base (11), and a shade (16) is provided to the outer circumference of the lamp. Wherein, a press disk (17) that allows vertical movement is pivoted to the base of the post (12), a compression coil (121) being inserted onto the post (12) with the upper end of the compression oil (121) holding against the holder (13) and the lower end pressing the press disk (17).

The adjusting threaded rod (15) is erected and locked to the top of the post (14) and a flange (151) protrudes from the outer circumference of the adjusting threaded rod (15) at where close to its upper section.

The shade (16) is made of multiple rings (161) into a tube adhered on its exterior a non-extendable paper. A loop (164) is disposed at the center of a later support (163) to an upper ring (162) to allow the penetration by the top section (152) of the adjusting threaded rod (15) and locked in place with a nut (153). A lower lever provided at the lower ring (165) is curved at its center an arc (167) to bypass the post (12) and to stretch up the shade (16) by being subject to the press disk (17) and the compression coil (121).

Two trenches of elevation (171) are provided in mirror position at the bottom of the press disk (17) and a groove (172) is defined between both elevations (171) to engage with the lever (166) of the lower ring (165).

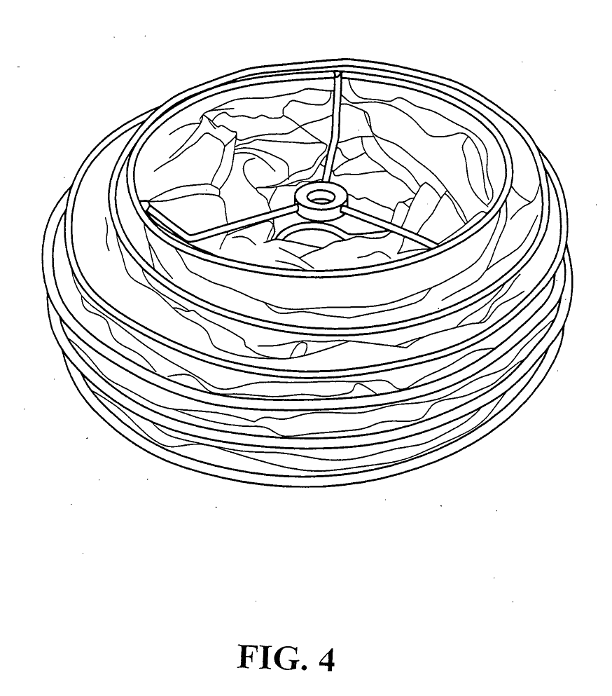

As illustrated in FIG. 4, the shade (16) of the preferred embodiment can be compressed and stretch into a given form as desired to reduce the packaging space and transportation cost.

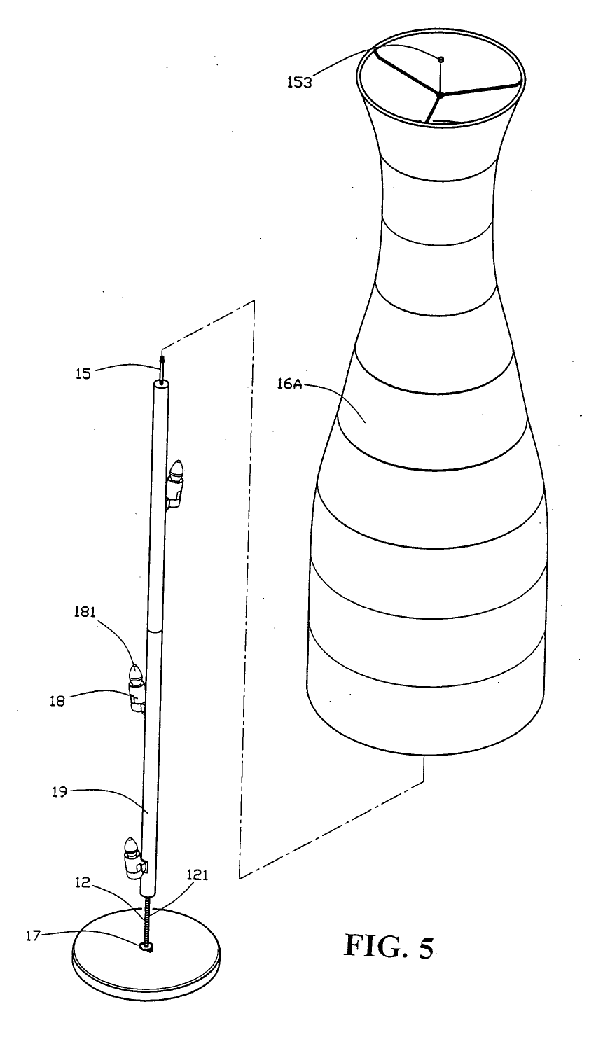

Now referring to FIG. 5 for another preferred embodiment of the present invention, a connection rod (19) is provided to the post (12) where inserted with the press disk (17) and the compression coil (121) for connection to multiple holders (18) and bulbs (181) in series. The adjusting threaded rod (15) is locked to the top of the connection rod (19) adapted with the nut (153) to permit the mounting of a shade (16A) in larger size of the present invention.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A floor lamp with a retractable shade essentially comprised of a base erected with a post screwed upwards in sequence a holder, a support and an adjusting threaded rod; and a shade to the outer circumference of the post is characterized by:
a press disk allowing vertical movement being pivoted to the bottom of the post, a compression coil being provided around the post, the top and the bottom of the compression coil respectively holding against the holder and the press disk;
the adjusting threaded rod being erected and locked to the top of the support, and a flange being protruded from the outer circumference of the adjusting threaded rod at where close to the upper section of the adjusting threaded rod;
the shade being comprised of multiple rings into a tube adhered on its exterior a piece of non-extendable paper; a loop being disposed at the lateral support of the upper ring to allow the insertion of the adjusting threaded rod before being locked with a nut; an arc being curved at the center of a lever provided to the lower ring to bypass the post to pull down the press disk and the compression coil to stretch up the shade; and
two trenches of elevation being provided in mirror position at the bottom of the press disk, and a groove being defined between both elevations to hold the lever at the lower ring of the shade.

2. A floor lamp with a retractable shade as claimed in claim 1, wherein, the top of the post inserted with the press disk and the compression coil is further provided with a connection rod to receive insertion of multiple holders and bulbs in series; and the top of the connection rod is locked with the adjusting threaded rod adapted with the nut to receive the mounting of the shade in larger size of the present invention.
